(19) United States
(12) Patent Application Publication
(10) Pub. No.: US 2024/0421533 A1
(43) Pub. Date: Dec. 19, 2024

(54) TAILCAP ASSEMBLY WITH A USB TYPE-C RECEPTACLE

(71) Applicants: Trent Zimmer, Youngsville, LA (US); Benjamin Mahan, Martinsville, IN (US)

(72) Inventors: Trent Zimmer, Youngsville, LA (US); Benjamin Mahan, Martinsville, IN (US)

(21) Appl. No.: 18/743,738

(22) Filed: Jun. 14, 2024

Related U.S. Application Data
(60) Provisional application No. 63/521,333, filed on Jun. 15, 2023.

(51) Int. Cl. H01R 13/627; F21V 23/04; F21V 23/06

(52) U.S. Cl. CPC H01R 13/627; F21V 23/0421; F21V 23/0435; F21V 23/06

(57) ABSTRACT

A tailcap assembly for a portable electronic device, such as a flashlight, and a complementary plug. The tailcap assembly includes a USB Type-C receptacle that allows other devices, such as a remote switch, to be connected. In some implementations, the USB Type-C receptacle is used to facilitate the delivery of power and/or the transmission of data to the portable electronic device. An example tailcap assembly comprises a USB Type-C receptacle accessible through an opening in the tailcap assembly. The opening is configured to receive and detachably retain a complementary plug inserted into the USB Type-C receptacle. The opening includes two contoured edges positioned opposite each other, between which a portion of the complementary plug is positioned when connected to the USB Type-C receptacle.

### CROSS-REFERENCE TO RELATED APPLICATION(S)

This application claims the benefit of U.S. Provisional Application Ser. No. 63/521,333, filed on Jun. 15, 2023, the entirety of which is incorporated herein by reference.

### TECHNICAL FIELD

This disclosure relates to a tailcap assembly having a USB Type-C receptacle.

### BACKGROUND

Weapon-mounted lights are important accessories for modern firearms, providing illumination for tactical operations, law enforcement, and personal defense. These lights are typically equipped with onboard push-button switches, allowing for direct control of the light's functions, such as momentary-on and constant-on modes. Onboard switches offer a straightforward and reliable means of activation but can sometimes be less convenient to operate, depending on the user's grip and shooting position. To address this, remote switches have been developed, enabling the user to activate the light from another location on the handguard of the firearm. Remote switches, often connected via a cable, provide enhanced ergonomics and allow for quicker, more intuitive light activation. This dual-control system enhances the flexibility and effectiveness of weapon-mounted lights, ensuring that users can maintain situational awareness in low-light and no-light environments. Typically, the tailcap assembly, which is threadedly secured to the weapon-mounted light, provides both the onboard switch and a port for connecting the remote switch.

Tailcap assemblies, which include an onboard push-button switch and a port for connecting a remote switch, have been adapted for use with other portable electronic devices, such as the KIJI® laser illuminator made by B. E. Meyers.

Accordingly, there exists a need for the tailcap assembly and the complementary plug disclosed herein. The present invention is primarily directed towards providing a tailcap assembly and a complementary plug configured to address these and other needs.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a tailcap assembly for a portable electronic device, such as a flashlight, and a complementary plug. The tailcap assembly includes a USB Type-C receptacle that allows other devices, such as a remote switch, to be connected. In some implementations, the USB Type-C receptacle is used to facilitate the delivery of power and/or the transmission of data to the portable electronic device.

An example tailcap assembly comprises a USB Type-C receptacle accessible through an opening in the tailcap assembly. The opening is configured to receive and detachably retain a complementary plug inserted into the USB Type-C receptacle. The opening includes two contoured edges positioned opposite each other, between which a portion of the complementary plug is positioned when connected to the USB Type-C receptacle.

Another example tailcap assembly comprises a tailcap configured to enclose a battery compartment of a portable electronic device, a USB Type-C receptacle, and a spring contact conductively connected to the USB Type-C receptacle. The USB Type-C receptacle is accessible through an opening in the tailcap. The opening is configured to receive and detachably retain a complementary plug inserted into the USB Type-C receptacle. The opening includes two contoured edges positioned opposite each other, between which a portion of the complementary plug is positioned when connected to the USB Type-C receptacle.

Yet another example tailcap assembly comprises a tailcap configured to enclose a battery compartment of a portable electronic device, a USB Type-C receptacle, an onboard switch configured to selectively close a circuit of the portable electronic device, and a spring contact conductively connected to both the USB Type-C receptacle and the onboard switch. The USB Type-C receptacle is accessible through an opening in the tailcap. The opening is configured to receive and detachably retain a complementary plug inserted into the USB Type-C receptacle. The opening includes two contoured edges positioned opposite each other, between which a portion of the complementary plug is positioned when connected to the USB Type-C receptacle.

### BRIEF DESCRIPTION OF THE DRAWINGS

FIG. 1 illustrates an isometric view of a tailcap assembly and a complementary plug, according to the principles of the present disclosure.

FIG. 2 illustrates another isometric view of the tailcap assembly and the complementary plug shown in FIG. 1.

FIG. 3 illustrates a rear elevational view of the tailcap assembly and the complementary plug shown in FIG. 1.

FIG. 4 illustrates a side elevational view of the tailcap assembly and the complementary plug shown in FIG. 1.

FIG. 5 illustrates a top plan view of the tailcap assembly and the complementary plug shown in FIG. 1.

FIG. 6 illustrates a cutaway view of the tailcap assembly and the complementary plug taken along line 6-6 shown in FIG. 5.

FIG. 7 illustrates a cutaway view of the tailcap assembly and the complementary plug taken along line 7-7 shown in FIG. 5.

FIG. 8 illustrates an isometric view of the tailcap assembly and the complementary plug shown in FIG. 1, with the complementary plug separated from the USB Type-C receptacle of the tailcap assembly.

FIG. 9 illustrates a top plan view of the tailcap assembly shown in FIG. 8.

FIG. 10 illustrates a side elevational view of the tailcap assembly shown in FIG. 8.

FIG. 11 illustrates an exploded isometric view of the tailcap assembly shown in FIG. 8.

FIG. 12 illustrates an isometric view of an insulator according to the principles of the present disclosure.

FIG. 13 illustrates another isometric view of the insulator shown in FIG. 12.

FIG. 14 illustrates an isometric view of a locking ring according to the principles of the present disclosure.

FIG. 15 illustrates a schematic diagram depicting the relationship between the electrical components of the tailcap assembly shown in FIG. 8.

Like reference numerals refer to corresponding parts throughout the several views of the drawings.

### DETAILED DESCRIPTION

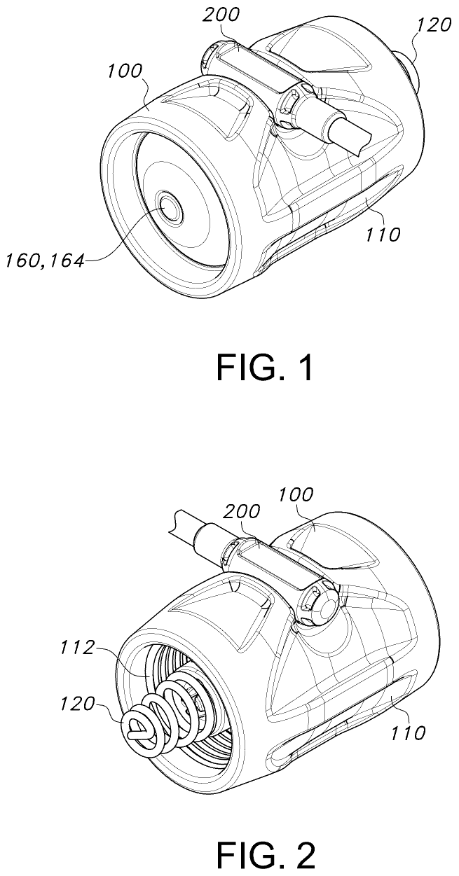

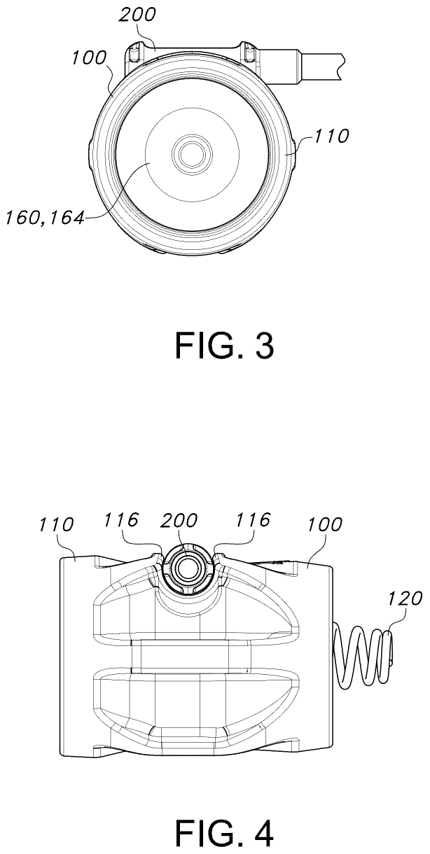

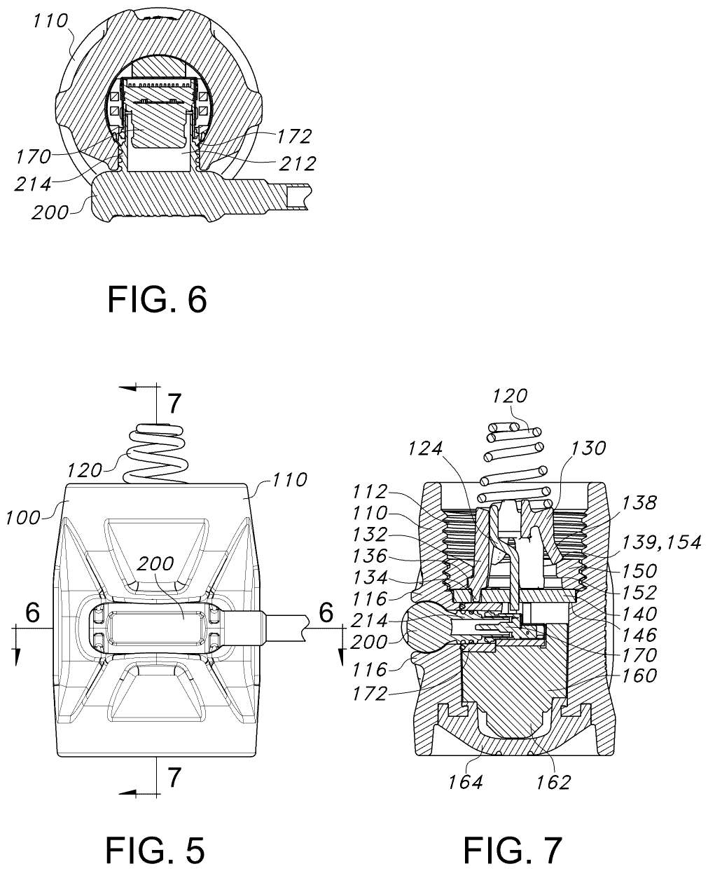

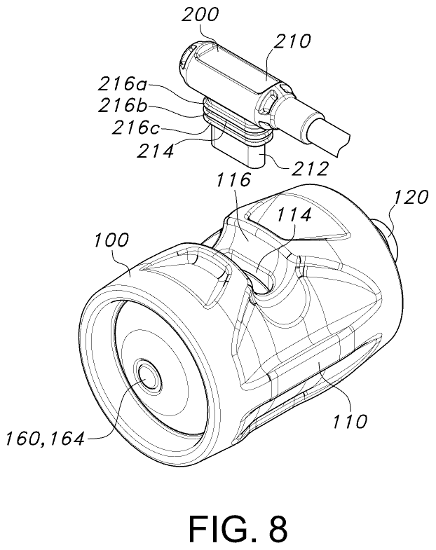

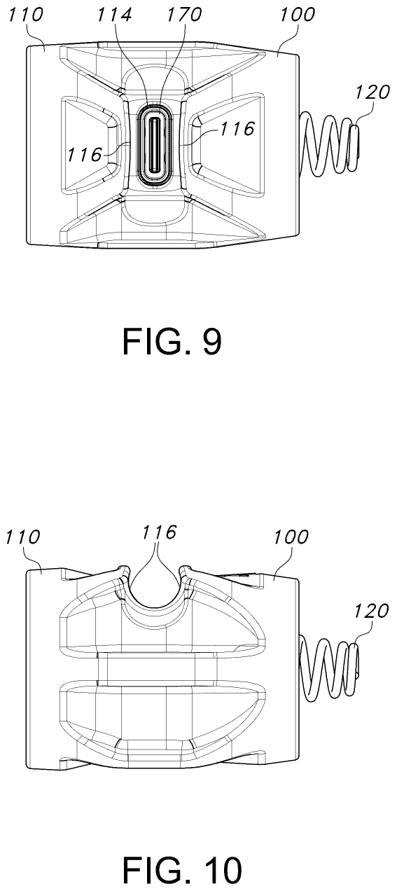

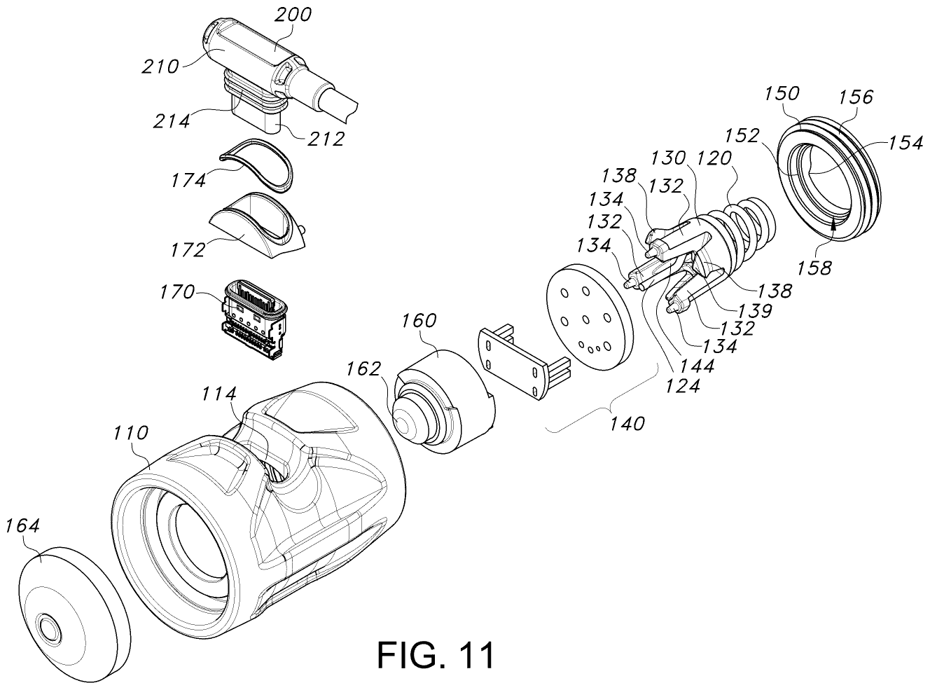

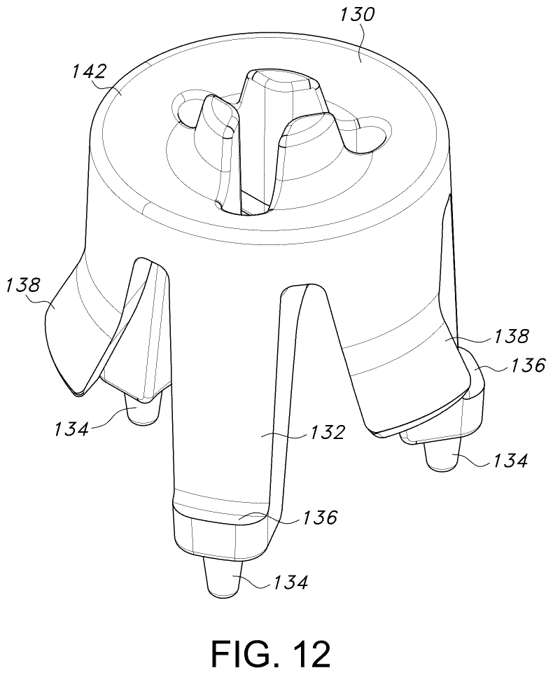

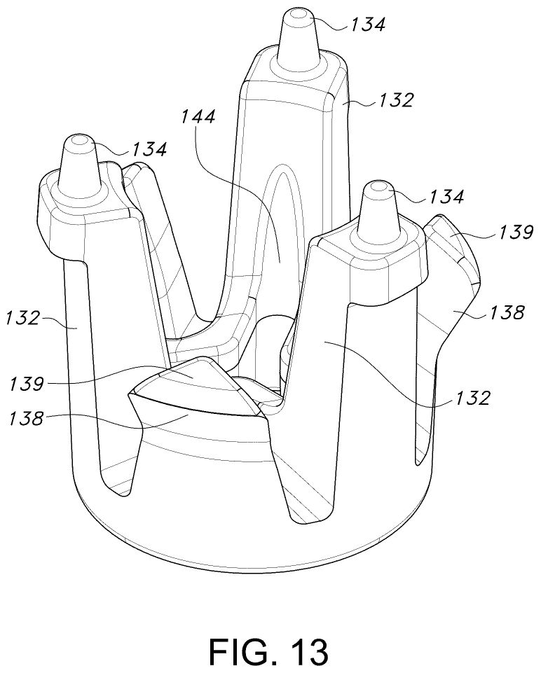

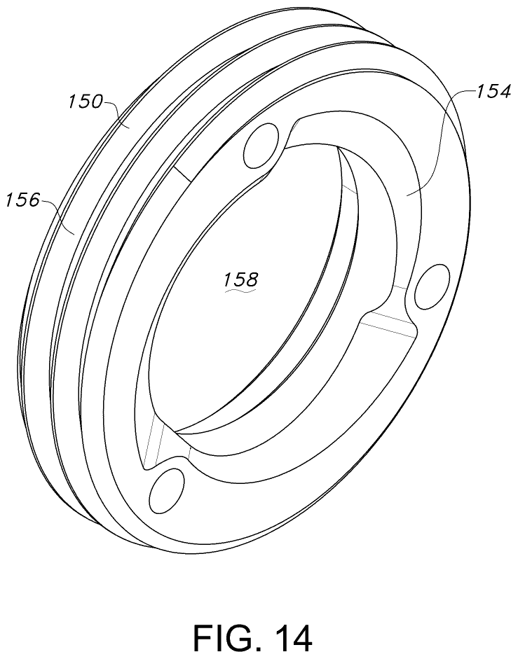

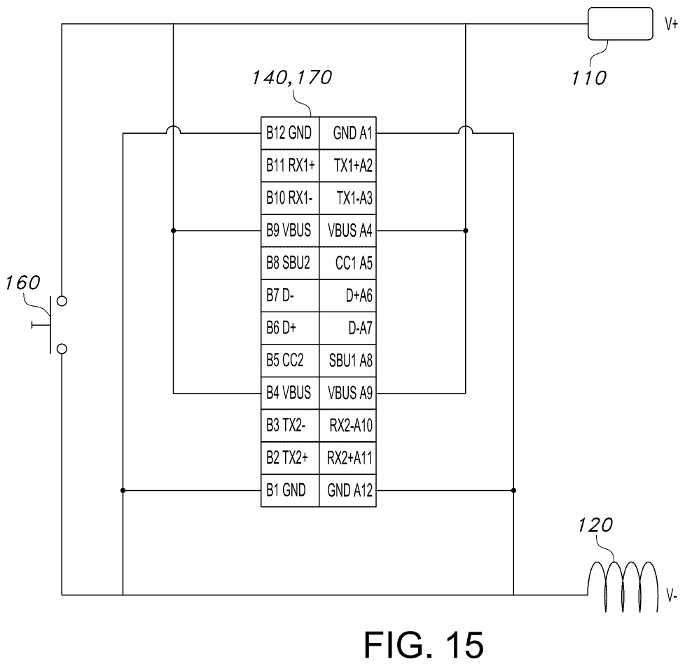

FIGS. 1 and 2 are isometric views of a tailcap assembly 100 with a USB Type-C receptacle 170, and a complementary plug 200. The tailcap assembly 100 is configured for use with a flashlight, but could be configured for use with other portable electronic devices (e.g., a laser aiming and/or illumination device). The included USB Type-C receptacle 170 allows other devices, such as a remote switch, to be connected. An example remote switch includes a pushbutton switch and a flexible cable having a complementary plug 200. In some implementations, the USB Type-C receptacle 170 is used to facilitate the delivery of power and/or the transmission of data to a portable electronic device equipped with the tailcap assembly 100.

The tailcap assembly 100 comprises a tailcap 110, a spring contact 120, an insulator 130, a printed circuit board (PCB) 140, a locking ring 150, an onboard switch 160, and a USB Type-C receptable 170.

The tailcap 110 can be removably secured to a rear end portion of a portable electronic device to enclose the battery compartment. The tailcap 110 is made of a polymer material, nylon 6 for example, and includes internal threads 112 that are threadedly securable to external threads on the rear end portion of a portable electronic device. When the tailcap 110 is secured to the portable electronic device, the spring contact 120 of the tailcap assembly 100 conductively engages the rear terminal of a battery positioned within the battery compartment of the portable electronic device. The spring contact 120 is conductively connected to the onboard switch 160 (a type of mechanical switch) and the USB Type-C receptacle 170 (a normally open circuit connector device), both of which are carried by the tailcap 110.

The spring contact 120 is supported by the insulator 130 of the tailcap assembly 100. The insulator 130 is made of nylon or another suitable non-conducting material. The insulator 130 is in contact with the PCB 140 positioned within the interior of the tailcap 110. The spring contact 120 extends through the insulator 130 and is soldered to the underlying PCB 140. The insulator 130 and PCB 140, and thereby the spring contact 120, are secured in position within the tailcap 110 by the locking ring 150.

The insulator 130 includes three legs 132, each of which have a post 134 that is received within a complementary opening in the PCB (see, e.g., FIG. 7). Each leg 132 of the insulator 130 defines a bearing surface 136, or ledge, against which an interior flange 152 of the locking ring 150 presses (see, e.g., FIG. 7). In this way, the insulator 130 is secured to the PCB 140 by the locking ring 150. The insulator 130 also includes three snap-fit tabs 138, the distal end of each having an angled surface 139 configured to cooperate with a chamfered surface 154 on an interior edge of the locking ring 150. More specifically, each angled surface 139 is configured to provide for an interference fit with the chamfered surface 154 of the locking ring 150 (see, e.g., FIG. 7). In this way, the locking ring 150 is prevented from unthreading after assembly.

The insulator 130 is configured to prevent compression and torsional forces from being transferred to the soldered joint connecting the spring contact 120 to the PCB 140. One end 142 of the insulator 130 is configured to serve as a bearing surface for a coil portion 122 of the spring contact 120. In this way, any compression force applied to the coil portion 122 of the spring contact 120 is not transferred to the soldered joint connecting it to the PCB 140. The insulator 130 also includes at least one spring retaining groove 144 configured to receive a dogleg portion 124 of the spring contact 120. The spring retaining groove 144 is shaped and dimension to prevent the spring contact 120 from rotating.

The PCB 140 rests against an internal annular shoulder within the interior of the tailcap 110 (see, e.g., FIG. 7). The PCB 140 includes a circular trace on one side that is in conductive contact with the locking ring 150.

The locking ring 150 has external threads 156 that are threadedly securable to the internal threads 112 of the tailcap 110. The locking ring 150 defines a central opening 158 through which the spring contact 120 and a portion of the insulator 130 extend. The locking ring is made of aluminum and has a chromate finish. However, the locking ring 150 could be made of another suitable material or combination of materials.

When the tailcap assembly 100 is secured to a portable electronic device, the onboard switch 160 is placed in circuit with the battery in the battery compartment of the portable electronic device. The onboard switch 160 includes a pushbutton actuator 162 used to selectively close the circuit to cause the light emitter, or other radiation source, of the portable electronic device to be energized by the battery. The pushbutton actuator 162 can be used to place the onboard switch 160 in a constant ON or OFF position, and may be configured to place the onboard switch 160 in a momentary ON position. The tailcap includes 110 an elastomeric flexible dome 164 that covers the pushbutton actuator 162 of the onboard switch 160.

The USB Type-C receptacle 170 is accessible through an opening 114 in the sidewall of the tailcap 110. The opening 114 is configured to receive and detachably retain a complementary connector or plug 200 inserted into the USB Type-C receptacle 170. The opening 114 includes two contoured edges 116, between which a portion of the plug 200 is positioned when connected to the USB Type-C receptacle 170. In this way, the USB Type-C receptacle 170 is protected from axial and lateral forces applied to the complementary plug 200. The contoured edges 116 are symmetrical and follow the form of the plug 200, ensuring proper alignment and enhanced retention within the USB Type-C receptacle 170 (see, e.g., FIG. 4). The two contoured edges 116 meet at the center of the opening 114, forming a U-shaped opening (see, e.g., FIG. 10). The opening 114 of the tailcap 110 is also configured to allow the complementary plug 200 to be inserted into the USB Type-C receptacle 170 in either orientation.

A remote switch may be connected to the USB Type-C receptacle 170, allowing the circuit to be selectively closed. This permits a light emitter or other radiation source of the portable electronic device to be selectively actuated.

In some implementations, an external power source having a complementary plug 200 may be connected to the USB Type-C receptacle 170 and used to power a portable electronic device equipped with the tailcap assembly 100.

The USB Type-C receptacle 170 is positioned within the tailcap 100 by a sealing structure 172 configured to seal the gap(s) between the USB Type-C receptacle 170 and the opening 114 in the sidewall of the tailcap 110. The sealing structure 172 is positioned between the onboard switch 160 and the PCB 140 of the tailcap assembly 100. The sealing structure 172 includes an elastomer gasket 174, positioned to prevent the ingress of fluid and other environmental debris into the interior of the tailcap 110.

Unless indicated otherwise, it will be understood that suitable wiring, traces, or a combination thereof, connect the electrical components of the tailcap assembly 100 disclosed herein.

In some implementations, the tailcap assembly 100 may not include an onboard switch 160.

In some implementations, the USB Type-C receptacle 170 may be located on the rear end of the tailcap assembly 100 instead of the onboard switch 160. Any such implementation would also include an opening 114 configured to receive and detachably retain a complementary plug 200 inserted into the USB Type-C receptacle 170.

The plug 200 is a USB Type-C plug comprising an outer shell 210 and a male connector 212. The outer shell 210 is configured (e.g., shaped and dimensioned) to fit between the contoured edges 116 of the opening 114 in the tailcap 110 that provides access to the USB Type-C receptacle 170. The male connector 212 is a rotationally symmetrical USB Type-C compatible connector. The plug 200 further comprises a gasket 214 that includes three circumferential ribs 216. The gasket 214 is configured to seal the USB Type-C receptacle 170. More specifically, a first rib 216a is in continuous contact with the opening 114 in the tailcap 110, a second rib 216b is in continuous contact with the sealing structure 172, and a third rib 216c is in contact with both the opening 114 in the tailcap 110 and the sealing structure 172.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A tailcap assembly comprising:
a USB Type-C receptacle accessible through an opening in the tailcap assembly, the opening is configured to receive and detachably retain a complementary plug inserted into the USB Type-C receptacle, the opening includes two contoured edges positioned opposite each other, between which a portion of the complementary plug is positioned when connected to the USB Type-C receptacle.

2. The tailcap assembly of claim 1, wherein the two contoured edges of the opening are symmetrical and contour around the portion of the complementary plug positioned therebetween.

3. A tailcap assembly comprising:
a tailcap configured to enclose a battery compartment of a portable electronic device;
a USB Type-C receptacle; and
a spring contact conductively connected to the USB Type-C receptacle;
wherein the USB Type-C receptacle is accessible through an opening in the tailcap, the opening is configured to receive and detachably retain a complementary plug inserted into the USB Type-C receptacle, the opening includes two contoured edges positioned opposite each other, between which a portion of the complementary plug is positioned when connected to the USB Type-C receptacle.

4. The tailcap assembly of claim 3, wherein the two contoured edges of the opening are symmetrical and contour around the portion of the complementary plug positioned therebetween.

5. A tailcap assembly comprising:
a tailcap configured to enclose a battery compartment of a portable electronic device;
a USB Type-C receptacle;
an onboard switch configured to selectively close a circuit of the portable electronic device; and
a spring contact conductively connected to both the USB Type-C receptacle and the onboard switch;
wherein the USB Type-C receptacle is accessible through an opening in the tailcap, the opening is configured to receive and detachably retain a complementary plug inserted into the USB Type-C receptacle, the opening includes two contoured edges positioned opposite each other, between which a portion of the complementary plug is positioned when connected to the USB Type-C receptacle.

6. The tailcap assembly of claim 5, wherein the two contoured edges of the opening are symmetrical and contour around the portion of the complementary plug positioned therebetween.
